(19) United States
(12) Patent Application Publication
(10) Pub. No.: US 2014/0370347 A1
(43) Pub. Date: Dec. 18, 2014

(54) FLEXIBLE BATTERY

(71) Applicant: SAMSUNG SDI CO., LTD., Yongin-si (KR)

(72) Inventors: Kangkook JUNG, Yongin-si (KR); S. Elena KANG, Yongin-si (KR)

(73) Assignee: SAMSUNG SDI CO., LTD., Yongin-si (KR)

(21) Appl. No.: 14/058,611

(22) Filed: Oct. 21, 2013

Related U.S. Application Data
(60) Provisional application No. 61/835,031, filed on Jun. 14, 2013.

(51) Int. Cl. H01M 2/02

(52) U.S. Cl. CPC H01M 2/0275; H01M 2/026; H01M 2220/30
USPC 429/94; 429/127

(57) ABSTRACT

A battery includes a flexible case, an electrode assembly in the flexible case, the electrode assembly having a length in a first direction, a width in a second direction perpendicular to the first direction, and a thickness in a third direction perpendicular to the first direction and the second direction, the length being greater than the width and greater than the thickness, and a flexible sealing member between the flexible case and the electrode assembly, the flexible sealing member being wrapped around the electrode assembly. The battery is flexible.

### CROSS-REFERENCE TO RELATED APPLICATION

The present application claims priority under 35 U.S.C. §119 to U.S. Provisional Application No. 61/835,031, filed on Jun. 14, 2013, and entitled: “Flexible Battery,” which is incorporated herein by reference in its entirety.

### BACKGROUND

1. Field

Embodiments relate to a flexible battery.

2. Description of the Related Art

Recently, with the development of lightweight and small-sized mobile electronic devices, batteries for supplying power to the mobile electronic devices have increasingly become miniaturized and light in weight for both driving use or back-up use.

### SUMMARY

Embodiments are directed to a battery, including a flexible case, an electrode assembly in the flexible case, the electrode assembly having a length in a first direction, a width in a second direction perpendicular to the first direction, and a thickness in a third direction perpendicular to the first direction and the second direction, the length being greater than the width and greater than the thickness, and a flexible sealing member between the flexible case and the electrode assembly, the flexible sealing member being wrapped around the electrode assembly. The battery is flexible.

A ratio of the length of the electrode assembly to the width of the electrode assembly may be 10:1 or greater.

A ratio of the length of the electrode assembly to the width of the electrode assembly may be about 10:1 to about 100:1.

A ratio of the width of the electrode assembly to the thickness of the electrode assembly may be about 0.5:1 to about 1.5:1.

The sealing member may have a width that is less than the length of the electrode assembly. The sealing member may be helically wound around the electrode assembly in the first direction.

The sealing member may be wrapped in a direction crossing the first direction of the electrode assembly.

The sealing member may be made of polyethylene (PE), polypropylene (PP), polyimide (PI), or a mixture thereof.

The sealing member may be a thermally shrinkable tape made of polyethylene terephthalate (PET), polytrimethylene terephthalate (PTT), or a mixture thereof.

The electrode assembly may include a first electrode plate, a second electrode plate, and a separator between the first electrode plate and the second electrode plate. The first electrode plate, the second electrode plate, and the separator may be flexibly deformable.

The first electrode plate, the second electrode plate, and the separator may be spirally wound with respect to an axis extending in the first direction.

The first electrode plate, the second electrode plate, and the separator may be spirally wound with respect to an axis extending in the second direction.

The first electrode plate, the second electrode plate, and the separator may be stacked to a predetermined thickness in the third direction.

The first electrode plate may include a first current collector and a first active material coated on the first current collector, the first current collector having a thickness of less than 20 μm. The second electrode plate may include a second current collector and a second active material coated on the second current collector, the second current collector having a thickness of less than 20 μm.

The first electrode plate may include a first current collector. The second electrode plate may include a second current collector. The first current collector and the second current collector may each be in a form of a mesh or a foam.

The first electrode plate and the second electrode plate may each include a plurality of through-holes having a diameter of about 1 μm to about 200 μm.

The flexible case may include a metal layer in a form of a thin film, a first insulating layer on a first surface of the metal layer, and a second insulating layer on a second surface of the metal layer.

The electrode assembly may be more easily bendable in the third direction than in the first direction or the second direction.

The battery may be bendable into a triangular shape, a rectangular shape, a pentagonal shape, a hexagonal shape, a trapezoidal shape, a circular shape, an elliptical shape, a spiral shape, a meandering shape, a serrated shape, or a sinusoid shape.

An electronic device may have a receiving region for a battery that is bent in a shape as described above.

Embodiments are also directed to an electronic device including a receiving region for a battery, the receiving region having a shape, and the battery being bent to conform to the shape of the receiving region.

### BRIEF DESCRIPTION OF THE DRAWINGS

Features will become apparent to those of skill in the art by describing in detail exemplary embodiments with reference to the attached drawings in which:

FIGS. 1A to 1C respectively illustrate a perspective view, a partially enlarged perspective view, and a cross-sectional view depicting a flexible battery according to an embodiment, and FIG. 1D is a perspective view illustrating an electrode assembly and a sealing member in the flexible battery according to an embodiment;

FIG. 2 illustrates a partially enlarged perspective view depicting an electrode assembly of the flexible battery according to an embodiment;

FIG. 3 illustrates a partially enlarged perspective view depicting an electrode assembly of a flexible battery according to another embodiment;

FIG. 4 illustrates a partially enlarged perspective view depicting an electrode assembly of a flexible battery according to another embodiment;

FIG. 5 illustrates a partially enlarged perspective view depicting an electrode assembly of a flexible battery according to another embodiment;

FIGS. 6A to 6C respectively illustrate a perspective view, a partially enlarged perspective view, and a cross-sectional view depicting a flexible battery according to another embodiment, and FIG. 6D illustrates a perspective view depicting an electrode assembly and a sealing member in the flexible battery according to another embodiment;

FIGS. 7A to 7M illustrate plan views depicting a two-dimensional warp of a flexible battery according to various other embodiments;

FIG. 8 illustrates a plan view depicting a three-dimensional warp of a flexible battery according to another embodiment;

FIGS. 9A and 9B respectively illustrate a rear view and a cross-sectional view depicting an external set having a flexible battery according to an embodiment mounted therein;

FIG. 10 illustrates a rear view depicting another external set having a flexible battery according to an embodiment mounted therein; and

FIGS. 11a and 11b illustrate cross-sectional views depicting first or second electrode plates according to another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout. As used herein, the term “and/or” includes any and all combinations of one or more of the associated listed items.

In addition, the terminology used herein is for the purpose of describing particular embodiments only and is not intended to be limiting thereof. As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer, and/or section from another. Thus, for example, a first member, a first element, a first region, a first layer and/or a first section discussed below could be termed a second member, a second element, a second region, a second layer and/or a second section without departing from the teachings.

In addition, the term “separator” used herein includes a separator commonly used for a liquid electrolyte battery using a liquid electrolyte having little affinity to the separator. Further, the term “separator” used herein includes an intrinsic solid polymer electrolyte and/or a gel solid polymer electrolyte, in which an electrolyte is firmly bound to a separator, so that the electrolyte and the separator should be interpreted as being identical with each other. Therefore, the meaning of the separator should be defined as having a meaning that is consistent with its meaning in the context of the present disclosure.

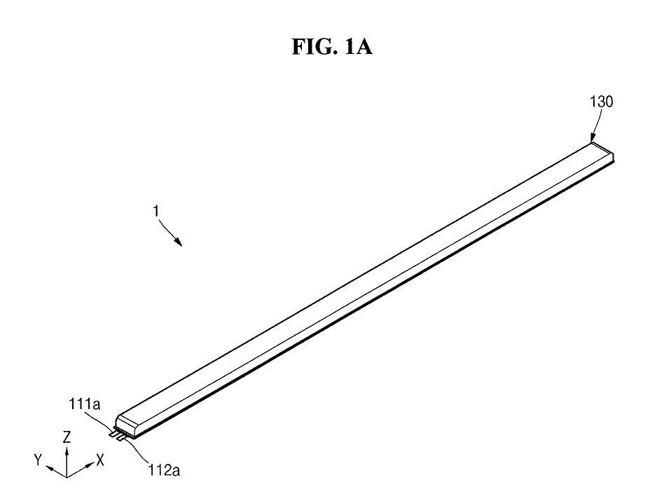

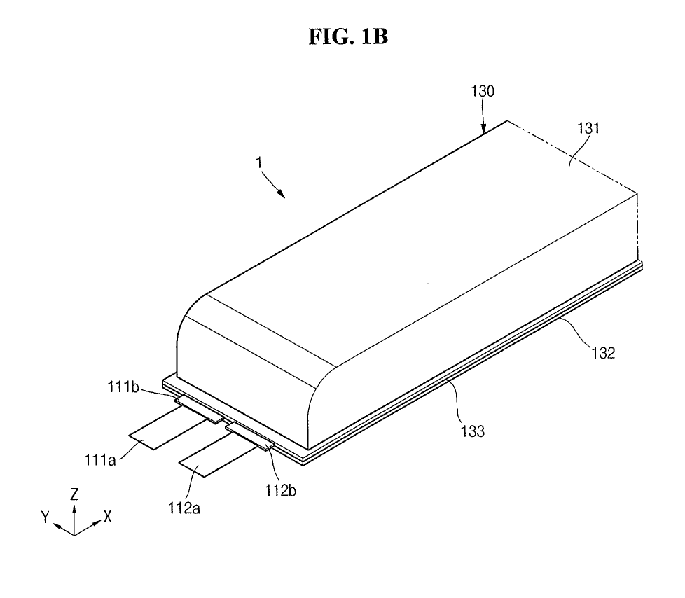

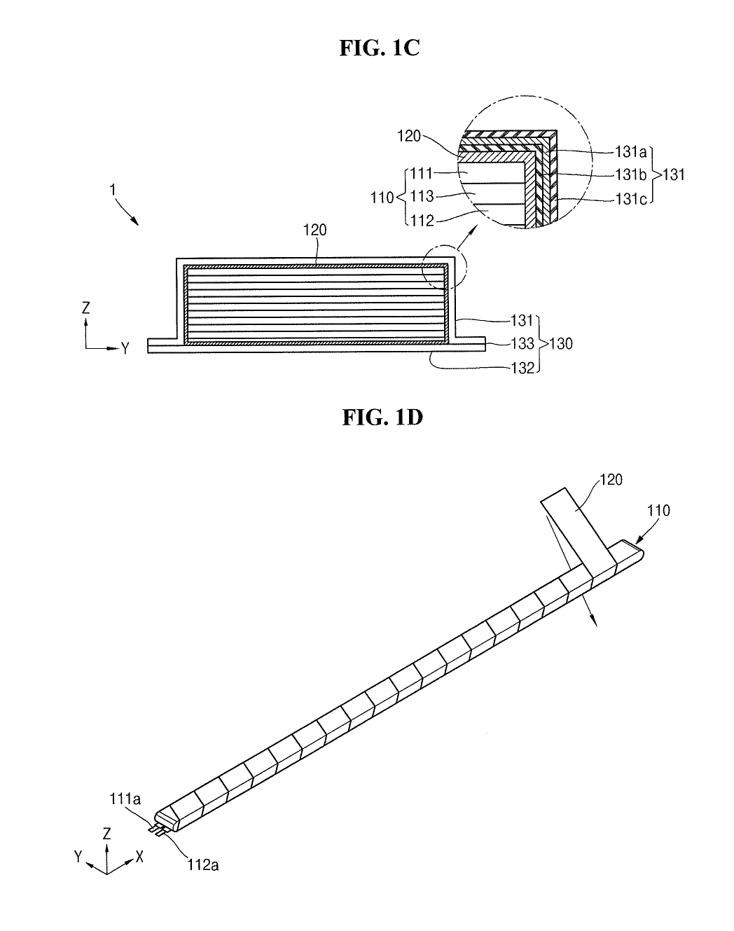

FIGS. 1A to 1C illustrate a perspective view, a partially enlarged perspective view, and a cross-sectional view depicting a flexible battery according to an embodiment, and FIG. 1D illustrates a perspective view depicting an electrode assembly and a sealing member in the flexible battery according to an embodiment.

As illustrated in FIGS. 1A to 1D, the flexible battery 1 according to the embodiment includes a rechargeable electrode assembly 110, a sealing member 120 wrapping the electrode assembly 110 and an outer case 130 protecting the electrode assembly 110 from external environments.

The electrode assembly 110 is longer in a first direction than in a second direction. For example, an aspect ratio of a first-direction length to a second-direction length of the electrode assembly 110 may be in a range of approximately 10:1 to 100:1. Here, the first direction and the second direction are perpendicular to each other.

The electrode assembly 110 may include a first electrode plate 111, a second electrode plate 112, and a separator 113 interposed therebetween. The first electrode plate 111, the second electrode plate 112, and the separator 113 may be wound in the first direction. The electrode assembly 110 may be wound in the first direction using the second direction as a winding shaft. Accordingly, the electrode assembly 110 may be easily warped or bent in a third direction perpendicular to the first and second directions. In an exemplified embodiment, assuming that the first direction is defined as the X axis, the second direction is defined as the Y axis, and the third direction is defined as the Z axis, the electrode assembly 110 may be wound in the first direction using the Y axis as a winding shaft. Accordingly, the electrode assembly 110 may be easily warped or bent in the Z axis. The electrode assembly 110 may have a rectangular or a square cross-sectional shape, as examples. In an exemplified embodiment, a ratio of a width to a thickness in the cross-section of the electrode assembly 110 (or a ratio of a Y-axis length to a Z-axis length) may be approximately in a range of 0.5:1 to 1.5:1. For example, a ratio of the width to the thickness of the electrode assembly 110 may be approximately 1:1. If the cross-section of the electrode assembly 110 is substantially rectangular, the degree of freedom may increase, and the flexibility of the electrode assembly 110 may be improved.

As described above, the thickness of the flexible battery 1 may be defined in the third direction (e.g., the Z axis), the width of the flexible battery 1 may be defined in the second direction (e.g., the Y axis).

The first electrode plate 111 may be a positive electrode plate, and the second electrode plate 112 may be a negative electrode plate, or vice versa. The first electrode plate 111 may include a first current collector (not shown) and a first active material (not shown), and the second electrode plate 112 may include a second current collector (not shown) and a second active material (not shown).

The first electrode plate 111 may be formed by coating a first active material made of a metal oxide, a metal sulfide, or a specific polymer, as examples, on the first current collector.

The first current collector may include, for example, aluminum, titanium, or an alloy thereof. The first current collector may be in the form of a thin film, a lath, a punched metal, or a net, as examples. In order to provide the flexible battery 1 as a thin film battery, a thickness of the first current collector may be smaller than, for example, 20 μm.

A first tab 111a may be formed in the first current collector to extend a predetermined length to the outside of the outer case 130. The first tab 111a may include, for example, aluminum, titanium, or an alloy thereof. A partial region of the periphery of the first tab 111a may be covered by a first insulation film 111b so as to not be shorted by the metal layer of the outer case 130.

The first active material used may vary according to the kind of battery manufactured. For example, in a case of manufacturing a lithium battery or a lithium ion battery, any suitable material that is capable of intercalating and deintercalating lithium ions may be used as the first active material. For example, the first active material may include a metal sulfide or oxide not containing lithium, such as TiS₂, MoS₂, NbSe₂, or V₂O₅, or a lithium composite oxide represented by a general formula LiₓMO₂, where M is one or more transition metals, and generally 0.05≦x≦1.10 according to the charged or discharged state of battery. The transition metal M may be Co, Ni, or Mn, as examples. Specific examples of the lithium composite oxide may include LiCO₂, LiNiO₂, LiNi_{y}Co_{1-y}O₂ (0<y<1), or LiMn₂O₄. The lithium composite oxide may generate a high voltage and may have a superior energy density.

Lithium cobalt oxide or lithium nickel oxide may be used as the first active material to attain a high voltage, a high volume density, and good cycle life characteristics. The lithium composite oxide may be prepared by pulverizing and mixing a carbonate, acetate, oxide, or hydride of lithium, and a carbonate, acetate, oxide, or hydride of cobalt, manganese, or nickel according to a desired composition ratio and sintering the mixture at a temperature in a range of 600 to 1,000° C. in an oxygen atmosphere. In addition, when an electrode is formed using one of the aforementioned first active materials, a suitable conductive agent or a binder may be further added.

The second electrode plate 112 may be formed by coating a second active material onto the second current collector.

The second current collector may include, for example, copper, nickel, or an alloy thereof. The second current collector may be in the form of a thin film, a lath, a punched metal, or a net, as examples. In order to provide the flexible battery 1 as a thin film battery, a thickness of the second current collector may be smaller than, for example, 20 μm.

In addition, a second tab 112a may be formed in the second current collector to extend a predetermined length to the outside of the outer case 130. The second tab 112a may include, for example, copper, nickel, or an alloy thereof. A partial region of the periphery thereof may be covered by a second insulation film 112b so as to not be shorted from the metal layer of the outer case 130.

The second active material used may vary according to the kind of battery manufactured. For example, in a case of manufacturing a lithium secondary battery, any suitable material that is capable of doping and undoping lithium ions, such as a hardly graphitizable carbon-based material or a graphite-like carbon material, can be used as the second active material, as examples. For example, the second active material may be a carbonaceous material, such as an organic polymer compound sintered product, carbon fiber, or activated carbon, prepared by sintering pyrolyzed carbons, cokes such as pitch cokes, needle cokes or petroleum cokes, graphites, glass-like carbons, phenol resin, furan resin, etc. at an appropriate temperature, and carbonizing the same. Examples of the material capable of doping and undoping lithium ions may also include a polymer such as polyacetylene or polypyrrole, or an oxide such as SnO₂. When an electrode is formed using one of the aforementioned second active materials, a conductive agent or a binder that is widely used in the art may be further added.

The separator 113 may be, for example, a porous polyolefin based separator or a ceramic separator. The polyolefin based separator may have a three-layered cylindrical pore structure of polypropylene (PP)/polyethylene (PE)/PP, or a single-layered net pore structure of PP or PE. The ceramic separator may be obtained, for example, by coating a ceramic onto a surface of the polyolefin based separator or by coating ceramic onto a surface of a non-woven fabric. The ceramic may be alumina, as an example.

A polymer electrolyte layer may be used as the separator 113. In this case, the polymer electrolyte layer may completely surround only the second electrode plate (negative electrode plate) 112. The polymer electrolyte layer may include, for example, a polymer solid electrolyte having a film separating characteristic, or a gel electrolyte having a plasticizer added thereto.

If the separator does not include a polymer electrolyte layer, a separate electrolyte may be required. The electrolyte used in the flexible battery 1 may include a lithium salt dissolved in a nonprotonic solvent, or a mixed solvent having two or more kinds of these solvents. Examples of the lithium salt may include LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ₊₁SO₂)(C_{y}F_{2y+1}SO₂) where, x and y are natural numbers, LiCl, LiI, or a mixture thereof. Examples of the nonprotonic solvent may include propylene carbonate, ethylene carbonate, butylene carbonate, benzonitrile, acetonitrile, tetrahydrofuran, 2-methyltetrahydrofuran, γ-butyrolactone, dioxolane, 4-methyldioxolane, N,N-dimethylformamide, dimethylacetoamide, dimethylsulfoxide, dioxane, 1,2-dimethoxyethane, sulfolane, dichloroethane, chlorobenzene, nitrobenzene, dimethylcarbonate, methylethylcarbonate, diethylcarbonate, methylpropylcarbonate, methylisopropylcarbonate, ethylbutylcarbonate, dipropylcarbonate, diisopropylcarbonate, dibutylcarbonate, diethyleneglycol, dimethylether, or a mixture thereof.

The electrode assembly 110 is flexibly deformable. To provide flexibility, the first current collector and/or the second current collector may be a mesh type. In other implementations, the first current collector and/or the second current collector may be a foam type. For example, the first current collector may be made of foamed aluminum, and the second current collector may be made of foamed copper and/or foamed nickel. The second current collector (negative electrode plate) may be made of a carbon fiber. In this case, the second current collector itself may be capable of doping and undoping lithium ions, which may be advantageous in view of battery capacity.

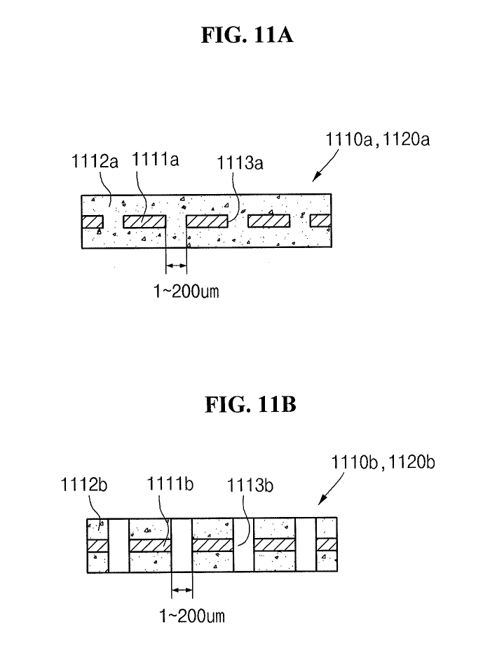

In addition, in order to increase the flexibility of the electrode assembly 110, a plurality of fine through holes 1113a may be arranged in the first or second electrode plate 1110a or 1120a, as shown in FIG. 11A. For example, the plurality of fine through holes 1113a having a diameter of approximately 1 to 200 μm may be arranged in the first or second current collector 1111a. Here, an active material 1112a may fill the fine through holes 1113a in the first or second current collector 1111a.

In another implementation, in order to further increase the flexibility of the electrode assembly 110, a plurality of fine through holes 1113b may be arranged throughout the first and second active materials 1112b, as well as through the first or second current collector 1111b in a first or second electrode plate 1110b or 1120b, as shown in FIG. 11B. The plurality of fine through holes 1113b may be formed to pass through the first or second electrode plate 1110b or 1120b. For example, a plurality of fine through holes 1113b having a diameter of approximately 1 to 200 μm may be arranged in the first or second electrode plate 1110b or 1120b.

In addition, in order to improve the flexibility of the electrode assembly 110, all of the aforementioned configurations may be applied to one electrode assembly 110.

In the battery manufacturing process, the sealing member 120 may wrap the electrode assembly 110 so as to allow the electrode assembly 110 to maintain a predetermined shape. For example, the sealing member 120 may be helically wound around the electrode assembly in the first direction. In an exemplary embodiment, the sealing member 120 may form a right angle, an obtuse angle, or an acute angle with respect to the first direction of the electrode assembly 110 and may wrap the electrode assembly 110. The sealing member 120 may wrap the electrode assembly 110 while forming a right angle, an obtuse angle or an acute angle with respect to the winding direction of the electrode assembly 110. For example, the sealing member 120 may be wound multiple times to form an obtuse angle or an acute angle, instead of a right angle, with respect to the first direction of the electrode assembly 110, thereby improving the flexibility of the electrode assembly 110. The sealing member 120 having a smaller width than a length of the electrode assembly 110 may be wound multiple times to form an obtuse angle or an acute angle with respect to the first direction of the electrode assembly 110, thereby improving the flexibility of the electrode assembly 110.

As examples, the sealing member 120 may be made of one selected from the group of polyethylene (PE), polypropylene (PP), polyimide (PI), or a mixture thereof. In other implementations, the sealing member 120 may be a thermally shrinkable tape. In an exemplary embodiment, the thermally shrinkable tape may be made of one selected from the group of polyethylene terephthalate (PET), polytrimethylene terephthalate (PTT), or a mixture thereof.

The outer case 130 may surround the electrode assembly 110 and the sealing member 120, thereby protecting the same from the external environment. The outer case 130 may be in the form of a pouch or an envelope. In addition, the outer case 130 may include a first outer case 131 surrounding a portion (e.g., roughly a top portion) of the electrode assembly 110 and the sealing member 120, and a second outer case 132 surrounding another portion (e.g., roughly a bottom portion) of the electrode assembly 110 and the sealing member 120. The outer case 130 may further include a fused region 133 formed between the electrode assembly 110 and the sealing member 120. While FIG. 1C illustrates a receiving area of the electrode assembly 110 as being formed only in the first outer case 131 and the fused region 133 as being formed at roughly a bottom portion of the outer case 130, in other implementations, the receiving area of the electrode assembly 110 may be formed in both of the first outer case 131 and the second outer case 132 and the fused region 133 may be formed at roughly a central portion of the outer case 130.

In order to allow the flexible battery 1 to be flexibly warped, the outer case 130 may include a metal layer 131a in the form of a thin film having a first surface and a second surface, a first insulation layer 131b formed on the first surface of the metal layer 131a and a second insulation layer 131c formed on the second surface of the metal layer 131a. The metal layer 131a may be made of one selected from the group of aluminum, copper, nickel and stainless steel. The first insulation layer 131b may be a thermally adhesive layer, and may be made, for example, of a denatured polyolefin resin such as casted polypropylene (CPP) or a tercopolymer of propylene, butylene and ethylene. The second insulation layer 131c may be made, for example, of polyethylene terephthalate (PET) or nylon. The fused region 133 may be formed on the outer portion of the assembly 110 in such a manner that the first insulation layer 131b of the first outer case 131 and a first insulation layer (not shown) of the second outer case 132 are thermally adhered to each other.

In such a manner, a flexible battery 1 may be provided that can be designed in various forms, for example, that can be warped in many ways.

In particular, the flexible battery 1 according to embodiments may have an aspect ratio in a range of about 10:1 to about 100. A thickness or a width of the flexible battery 1 may be longer than a length thereof. Therefore, the flexible battery 1 according to embodiments may be housed in various modified receiving regions, rather than in a conventional battery receiving region.

For example, a variety of curved receiving regions, including receiving regions shaped like a triangle, a rectangle, a pentagon, a hexagon, a trapezoid, a circle, an ellipse, a spiral, a meander, a serration, or a sinusoid, may be formed in the external set and the flexible battery 1 according to embodiments may be received in the receiving regions.

Therefore, according to embodiments, the design of the external set or the architecture of a circuit may not be limited by the receiving region of the external set occupied by the flexible battery 1, so that the external set may have a wider variety of shapes and may be further miniaturized, slimmer and lighter in weight.

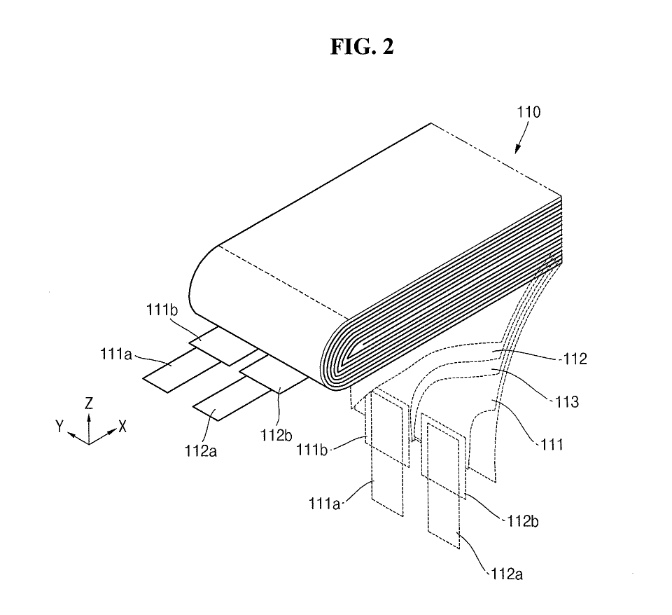

FIG. 2 illustrates a partially enlarged perspective view depicting an electrode assembly of the flexible battery according to an embodiment.

As illustrated in FIG. 2, the electrode assembly 110 may be formed by being wound in the first direction using the second direction as a winding shaft. The first electrode plate 111, the second electrode plate 112, and the separator 113 may be wound multiple times in the first direction using the second direction as a winding shaft. In such a manner, the first direction (e.g., the X axis) may become the winding direction, thereby allowing the electrode assembly 110 to be more easily warped in the third direction (e.g., the Z axis).

The first tab 111a may be electrically connected to the first electrode plate 111, and the second tab 112a may be electrically connected to the second electrode plate 112. The first tab 111a and the second tab 112a may extend a predetermined length to the outside of the electrode assembly 110 in the first direction. A direction in which the first tab 111a and the second tab 112a extend may be substantially parallel to the first direction.

As described above, when the first tab 111a and the second tab 112a extend substantially parallel to the first direction, the flexible battery employing the first tab 111a and the second tab 112a extending in parallel may be more easily handled in the course of manufacturing the battery.

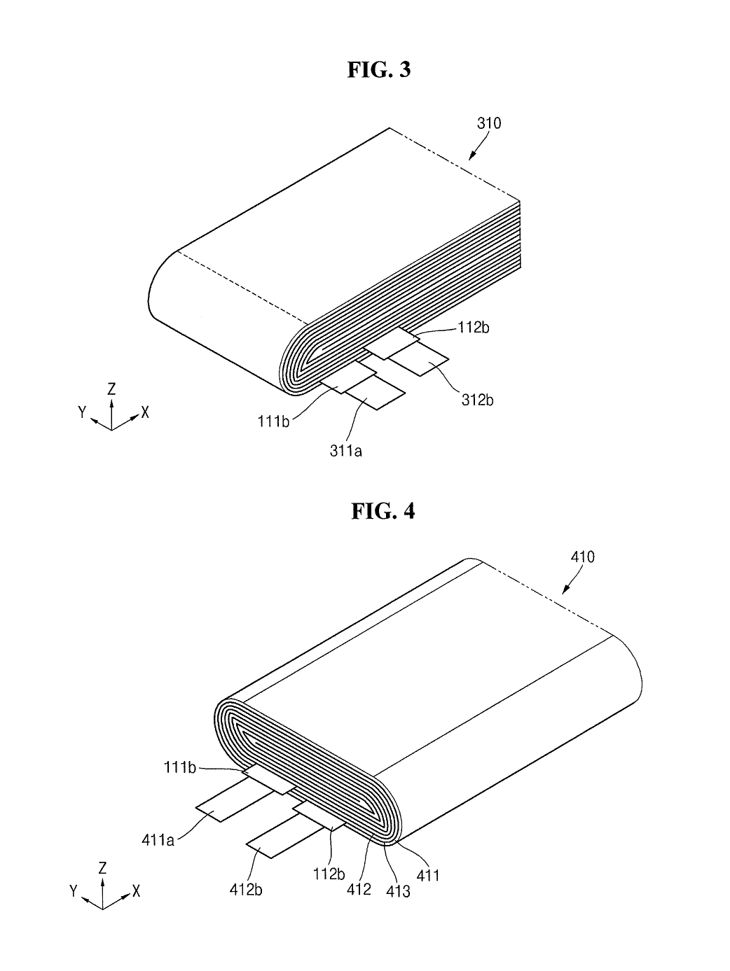

FIG. 3 illustrates a partially enlarged perspective view depicting an electrode assembly of a flexible battery according to another embodiment.

As illustrated in FIG. 3, a first tab 311a and a second tab 312a may extend to the outside of the electrode assembly 310 in the second direction. The first tab 311a and the second tab 312a extend in a direction substantially parallel to the second direction.

FIG. 4 illustrates a partially enlarged perspective view depicting an electrode assembly of a flexible battery according to another embodiment.

As illustrated in FIG. 4, the electrode assembly 410 may be formed by being wound in the second direction using the first direction as a winding shaft. A first electrode plate 411, a second electrode plate 412, and a separator 413 may be wound multiple times in the second direction using the first direction as a winding shaft. As described above, when the first direction is used as the winding shaft, widths of the first electrode plate 411, the second electrode plate 412 and the separator 413 increase, thereby facilitating alignment of the first electrode plate 411, the second electrode plate 412 and the separator 413.

In addition, the first tab 411a and the second tab 412a may extend to the outside of the electrode assembly 410 in the first direction. The first tab 411a and the second tab 412a may extend in a direction substantially parallel to the first direction. In some implementation, the first tab 411a and the second tab 412a may extend in a direction substantially parallel to the second direction.

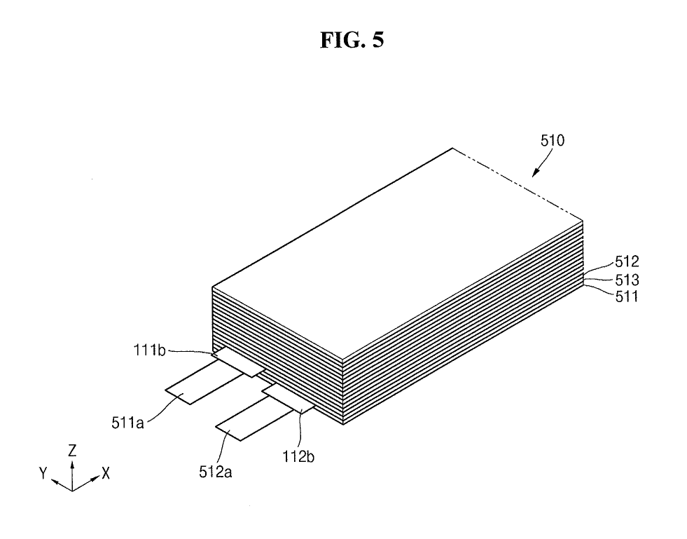

FIG. 5 illustrates a partially enlarged perspective view depicting an electrode assembly of a flexible battery according to another embodiment.

As illustrated in FIG. 5, the electrode assembly 510 may be provided in the form of a stack. A first electrode plate 511, a second electrode plate 512, and a separator 513 interposed therebetween may be stacked to a predetermined thickness in the third direction perpendicular to the first direction and the second direction.

In addition, the first electrode plate 511 and the second electrode plate 512 may extend to the outside of the electrode assembly 510 in the first direction. In some implementations, the electrode plate 511 and the second electrode plate 512 may extend in a direction parallel to the second direction.

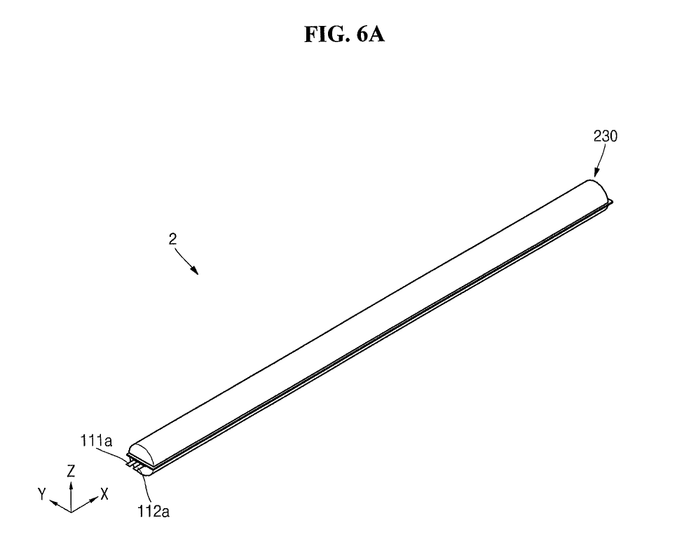

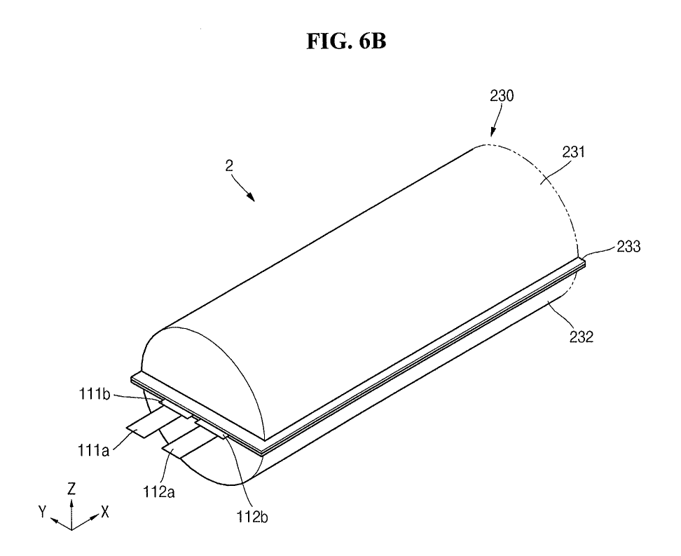

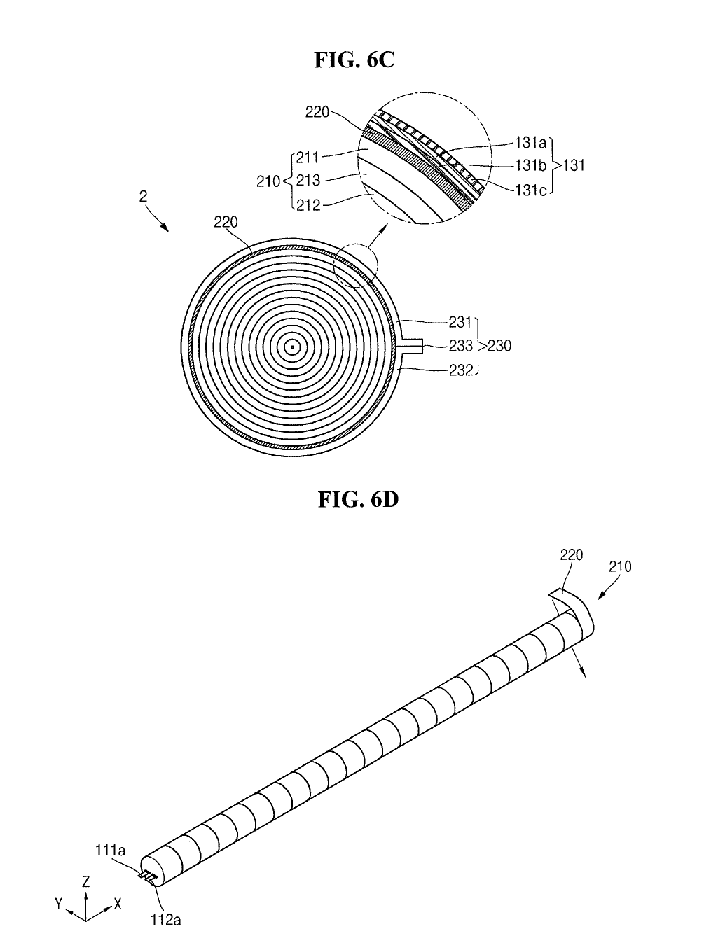

FIGS. 6A to 6C illustrate a perspective view, a partially enlarged perspective view, and a cross-sectional view depicting a flexible battery according to another embodiment, and FIG. 6D is a perspective view illustrating an electrode assembly and a sealing member in the flexible battery according to another embodiment.

The flexible battery 2 shown in FIGS. 6A to 6D may be substantially the same as the flexible battery 1 shown in FIGS. 1A to 1D in view of configurations and materials, and the following description will focus on differences between the flexible batteries 1 and 2.

As illustrated in FIGS. 6A to 6D, the flexible battery 2 according to embodiments includes an electrode assembly 210, a sealing member 220, and an outer case 230. The electrode assembly 210 is substantially cylindrical. Accordingly, the sealing member 220 and the outer case 230 may also be substantially cylindrical.

The electrode assembly 210 may be formed by being wound in the second direction using the first direction as a winding shaft. The first electrode plate 211, the second electrode plate 212, and the separator 213 interposed therebetween may be wound multiple times in the second direction (e.g., the Y axis) in a substantially cylindrical form using the first direction (e.g., the X axis) as a winding shaft, thereby completing the cylindrical electrode assembly 210.

Therefore, unlike the flexible battery 1 shown in FIG. 1A, the flexible battery 2 shown in FIG. 6A may be easily warped not only in the third direction (e.g., the Z axis) but also in the first direction (e.g., the X axis) and/or the second direction (e.g., the Y axis) perpendicular to the third direction.

Accordingly, the flexible battery 2 may be warped in various manners, that is, in a 2D manner or a 3D manner.

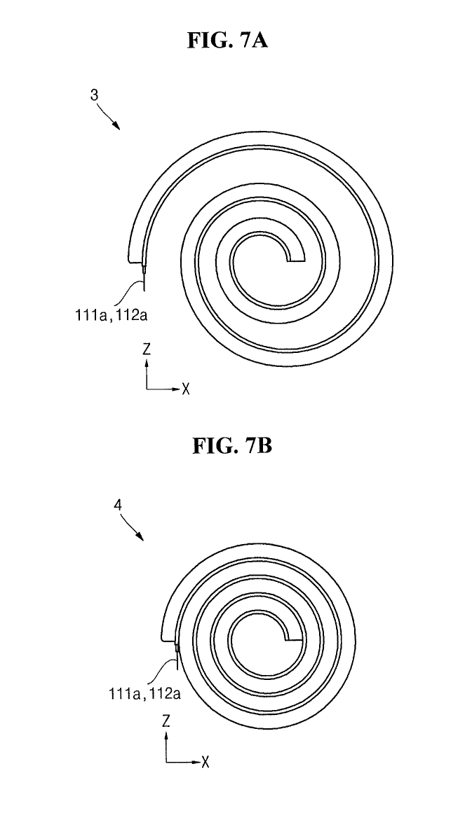

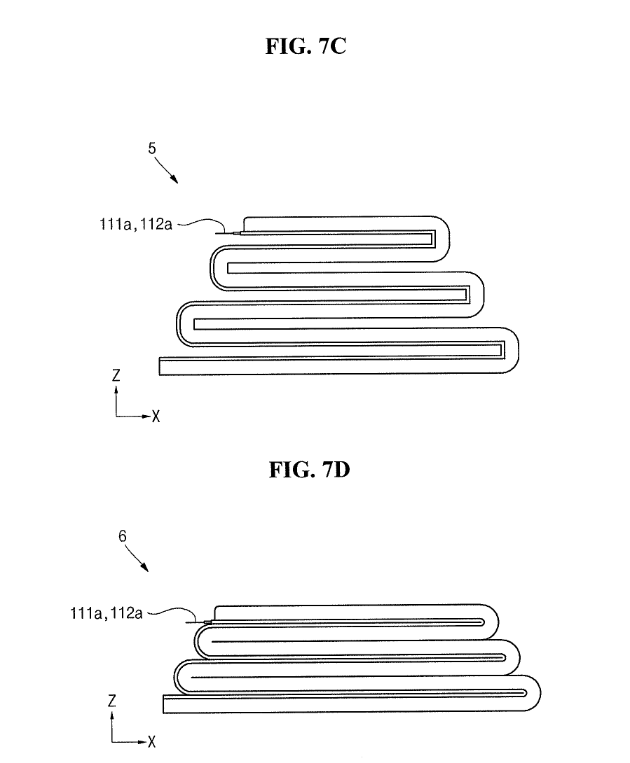

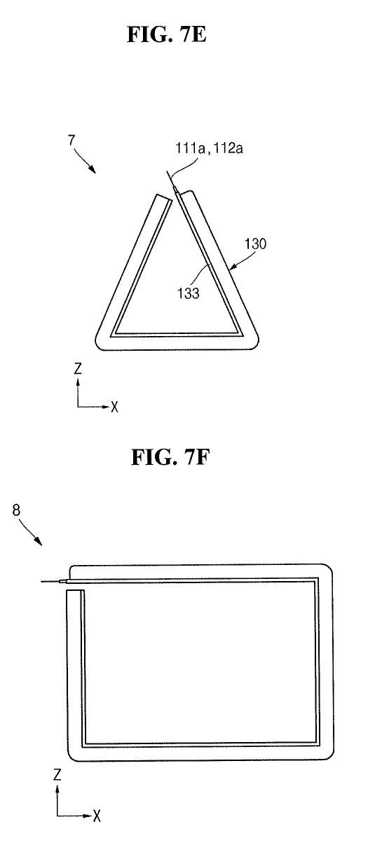

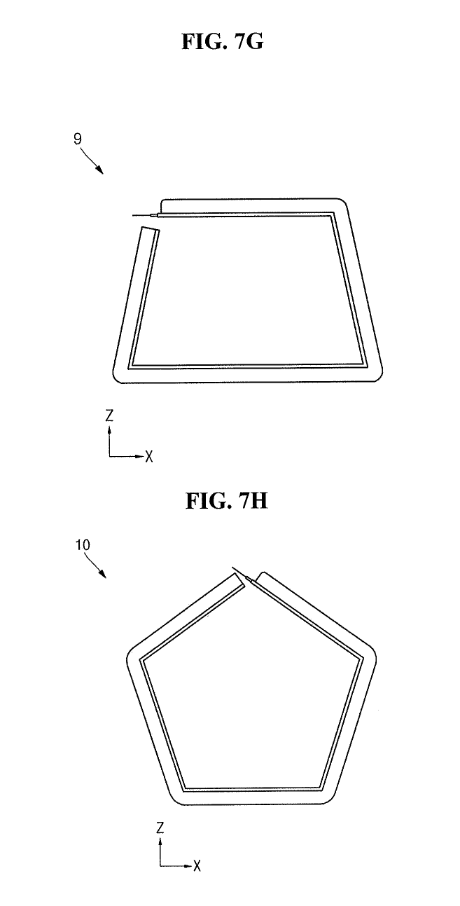

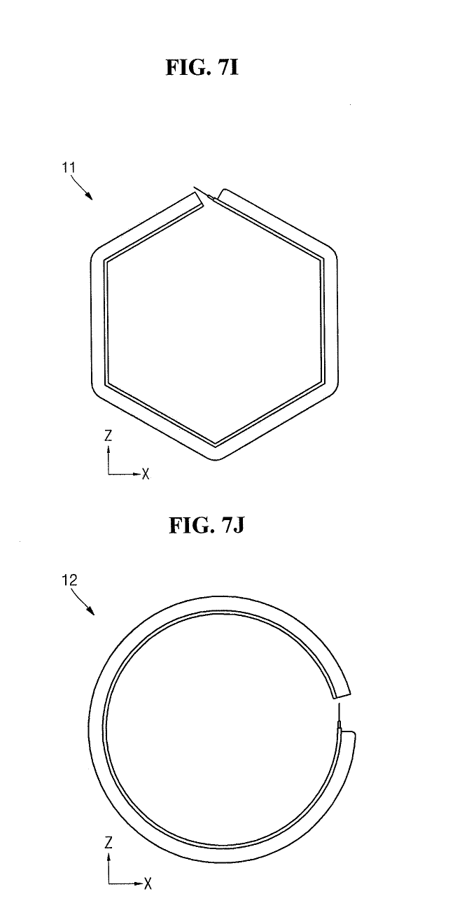

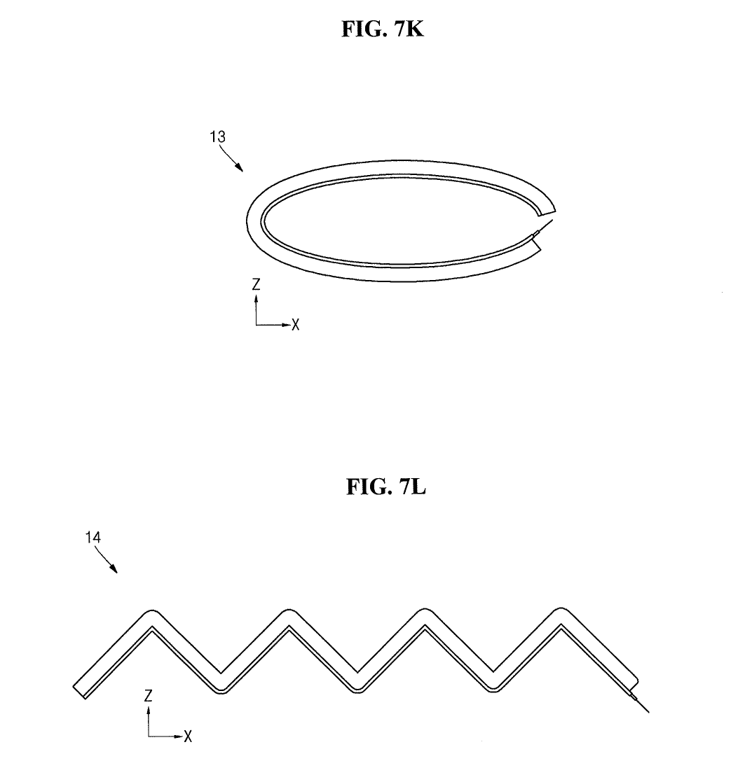

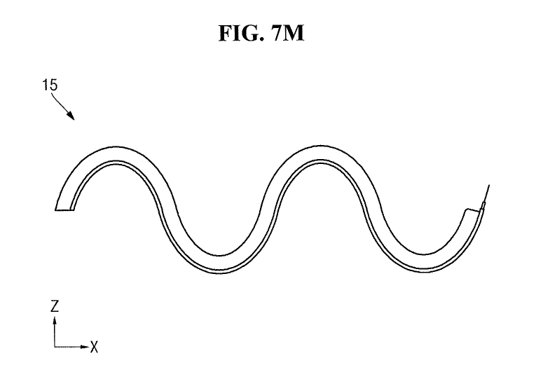

FIGS. 7A to 7M illustrate plan views depicting a two-dimensional warp of a flexible battery according to various embodiments.

The flexible battery used for the illustrated warp may be the same as that shown in FIGS. 1A to 1D. The warp of the flexible battery 1 may be made in the 2D manner on a plane formed by the first direction (e.g., the X axis) and the third direction (e.g., the Z axis), as an example.

As illustrated in FIGS. 7A and 7B, flexible batteries 3 and 4 may be bent in the form of spirals not in contact with each other or in the form of spirals in contact with each other. A tab (a first tab or a second tab) may be positioned on the outermost end or the innermost end of the flexible battery 3 or 4.

As illustrated in FIGS. 7C and 7D, flexible batteries 5 and 6 may be bent in the form of meanders not in contact with each other or in the form of meanders in contact with each other.

As illustrated in FIGS. 7E, 7F, 7G, 7H, 7I, 7J, and 7K, flexible batteries 7, 8, 9, 10, 11, 12, and 13 may be bent in the form of a triangle, a rectangle, a trapezoid, a pentagon, a hexagon, a circle, or an ellipse, respectively. The fused region 133 may be formed to be relatively close to one side of the outer case 130 in view of the thickness of the outer case 130. For example, the fused region 133 may be positioned in a region having a small radius of curvature to allow the battery to be easily warped.

As illustrated in FIGS. 7L and 7M, flexible batteries 14 and 15 may be warped in the form of a serration or in a sinusoid form (for example, as a cosine wave).

The flexible battery according to embodiments may be designed in various forms according to space characteristics or limitations of the external set. The forms of warps of the flexible battery are not limited to those illustrated herein.

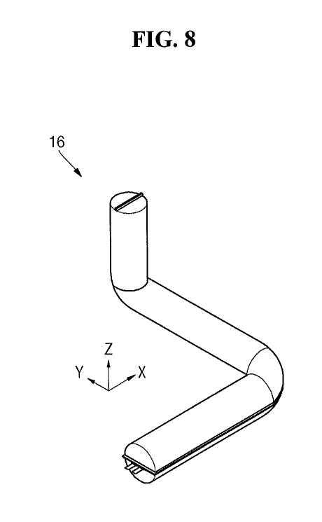

FIG. 8 illustrates a plan view depicting a three-dimensional warp of a flexible battery according to another embodiment.

The flexible battery 2 used for the illustrated warp may be the same as that shown in FIGS. 6A to 6D. In addition, the warp of the flexible battery 2 may be made in the 3D manner on a plane formed by the first direction (e.g., the X axis) and the second direction (e.g., the Y axis) and a surface formed by the second direction (e.g., the Y axis) and the third direction (e.g., the Z axis), for example. The warp of the flexible battery 16 may be made on a plane formed by the first direction (e.g., the X axis) and the third direction (e.g., the Z axis).

As described above, the flexible battery 16 according to embodiments may be freely warped not only in the 2D manner, but also in the 3D manner, thereby allowing the flexible battery 16 to be warped without being hindered by space characteristics or limitations of the external set.

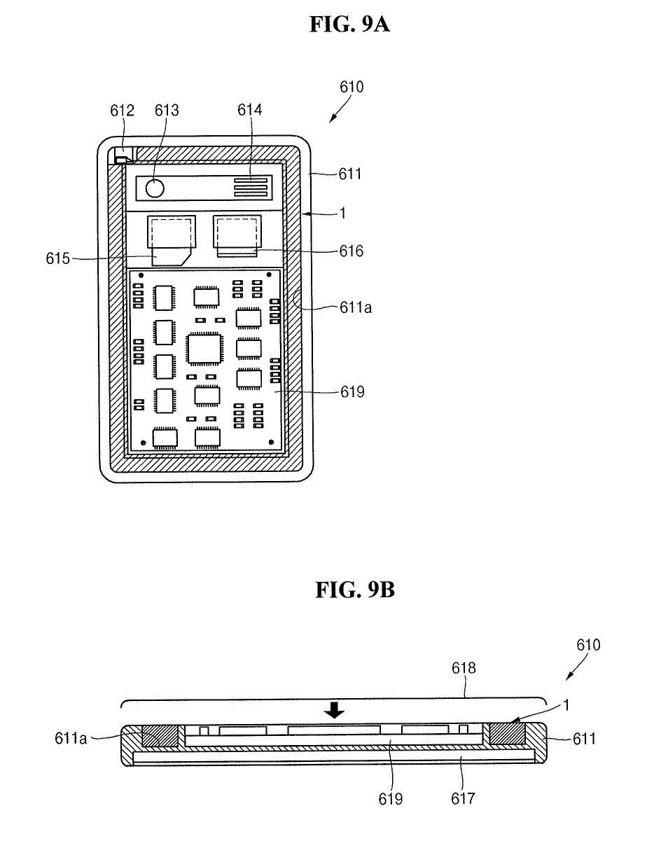

FIGS. 9A and 9B illustrate a rear view and a cross-sectional view depicting an external set having a flexible battery according to embodiments mounted therein.

As illustrated in FIGS. 9A and 9B, the flexible battery 1 may be received in an extra receiving region, different from a conventional battery receiving region. For example, an extra receiving region 611a may be provided to include a substantially rectangular plane along the perimeter of a housing 611 forming an external set 610. The flexible battery 1 may be received in the extra receiving region 611a. A circuit board 619, for example, may be positioned in the conventional battery receiving region, thereby providing an external set 610 that is further miniaturized and has a wider variety of forms than in the conventional case.

In FIG. 9, reference numeral 612 denotes a protective circuit module electrically connected to the flexible battery 1, reference numeral 613 denotes a camera module, reference numeral 614 denotes a speaker module, reference numeral 615 denotes a USIM chip, reference numeral 616 denotes an external memory device, reference numeral 617 denotes a display device, and reference numeral 618 denotes a protection cover, as examples. The illustrated external set 610 may be, for example, a smart phone.

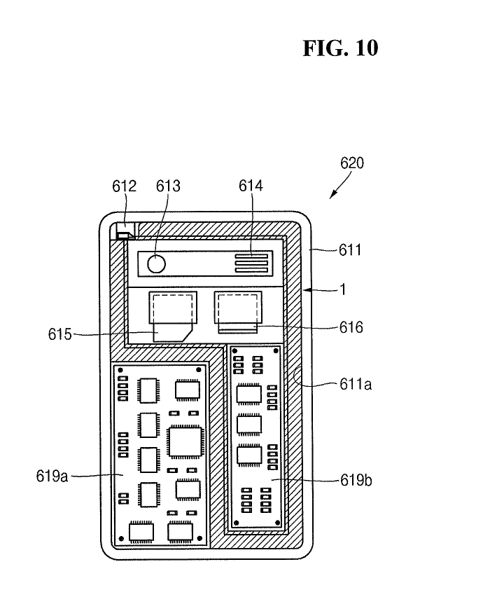

FIG. 10 illustrates a rear view depicting another external set having a flexible battery according to embodiments mounted therein.

As illustrated in FIG. 10, an extra receiving region 611a may be provided, the extra receiving region 611a having a substantially closed curve along the perimeter and the inside of a housing 611 forming an external set 620. The flexible battery 1 may be received in the extra receiving region 611a. In addition, circuit boards 619a and 619b may further be provided inside or outside the flexible battery 1.

The receiving type for the flexible battery 1 is provided only for illustration, and the flexible batteries 2 to 15 illustrated in FIGS. 7A to 7M may also be received in an external set in a 2D manner. Further, the flexible battery 16 illustrated in FIG. 8 may be received in an external set in a 3D manner. In addition, the flexible battery according to embodiments may also be received in the external set in various manners not illustrated herein.

By way of summation and review, lithium ion secondary batteries that have a high energy density or output density and are rechargeable have been developed. For compact or portable electronic devices, it is advantageous to efficiently use a receiving space in the electronic device.

Embodiments provide a flexible battery that can be designed in a desired form. Accordingly, the design of the external set or the architecture of a circuit, such as in an electronic device, is not restricted by the need to provide a conventional space to be occupied by the battery. Therefore, the external set may have a wider variety of shapes and may be further miniaturized, slimmer and lighter in weight

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A battery, including:
a flexible case;
an electrode assembly in the flexible case, the electrode assembly having a length in a first direction, a width in a second direction perpendicular to the first direction, and a thickness in a third direction perpendicular to the first direction and the second direction, the length being greater than the width and greater than the thickness; and
a flexible sealing member between the flexible case and the electrode assembly, the flexible sealing member being wrapped around the electrode assembly,
wherein the battery is flexible.

2. The battery as claimed in claim 1, wherein, a ratio of the length of the electrode assembly to the width of the electrode assembly is 10:1 or greater.

3. The battery as claimed in claim 1, wherein, a ratio of the length of the electrode assembly to the width of the electrode assembly is about 10:1 to about 100:1.

4. The battery as claimed in claim 1, wherein a ratio of the width of the electrode assembly to the thickness of the electrode assembly is about 0.5:1 to about 1.5:1.

5. The battery as claimed in claim 1, wherein:
the sealing member has a width that is less than the length of the electrode assembly, and
the sealing member is helically wound around the electrode assembly in the first direction.

6. The battery as claimed in claim 1, wherein the sealing member is wrapped in a direction crossing the first direction of the electrode assembly.

7. The battery as claimed in claim 1, wherein the sealing member is made of polyethylene (PE), polypropylene (PP), polyimide (PI), or a mixture thereof.

8. The battery as claimed in claim 1, wherein the sealing member is a thermally shrinkable tape made of polyethylene terephthalate (PET), polytrimethylene terephthalate (PTT), or a mixture thereof.

9. The battery as claimed in claim 1, wherein:
the electrode assembly includes a first electrode plate, a second electrode plate, and a separator between the first electrode plate and the second electrode plate, and
the first electrode plate, the second electrode plate, and the separator are flexibly deformable.

10. The battery as claimed in claim 9, wherein the first electrode plate, the second electrode plate, and the separator are spirally wound with respect to an axis extending in the first direction.

11. The battery as claimed in claim 9, wherein the first electrode plate, the second electrode plate, and the separator are spirally wound with respect to an axis extending in the second direction.

12. The battery as claimed in claim 9, wherein the first electrode plate, the second electrode plate, and the separator are stacked to a predetermined thickness in the third direction.

13. The battery as claimed in claim 9, wherein:
the first electrode plate includes a first current collector and a first active material coated on the first current collector, the first current collector having a thickness of less than 20 μm; and
the second electrode plate includes a second current collector and a second active material coated on the second current collector, the second current collector having a thickness of less than 20 μm.

14. The battery as claimed in claim 9, wherein:
the first electrode plate includes a first current collector,
the second electrode plate includes a second current collector, and
the first current collector and the second current collector are each in a form of a mesh or a foam.

15. The battery as claimed in claim 9, wherein the first electrode plate and the second electrode plate each include a plurality of through-holes having a diameter of about 1 μm to about 200 μm.

16. The battery as claimed in claim 1, wherein the flexible case includes a metal layer in a form of a thin film, a first insulating layer on a first surface of the metal layer, and a second insulating layer on a second surface of the metal layer.

17. The battery as claimed in claim 1, wherein the electrode assembly is more easily bendable in the third direction than in the first direction or the second direction.

18. The battery as claimed in claim 1, wherein the battery is bendable into a triangular shape, a rectangular shape, a pentagonal shape, a hexagonal shape, a trapezoidal shape, a circular shape, an elliptical shape, a spiral shape, a meandering shape, a serrated shape, or a sinusoid shape.

19. An electronic device having a receiving region for a battery that is bent in a shape as claimed in claim 18.

20. An electronic device comprising a receiving region for a battery, the receiving region having a shape, and the battery being bent to conform to the shape of the receiving region.
